(19) United States
(12) Patent Application Publication
(10) Pub. No.: US 2018/0285925 A1
(43) Pub. Date: Oct. 4, 2018

(54) RESOURCE OPTIMIZATION USING AUDIENCE SEGMENTATION DATA

(71) Applicant: CDK Global, LLC, Hoffman Estates, IL (US)

(72) Inventor: Keith Zackrone, Issaquah, WA (US)

(21) Appl. No.: 15/478,042

(22) Filed: Apr. 3, 2017

(51) Int. Cl. G06Q 30/02

(52) U.S. Cl. CPC G06Q 30/0249; G06Q 30/0204; G06Q 30/0275; G06Q 30/0202

(57) ABSTRACT

The present disclosure provides for resource optimization using audience segmentation data. Resource optimization can include creating the audience segment, from the consumer data, generating a needs forecast comprising a needed budget based on the cost to generate the vehicle model visit, the sales goals data, the vehicle sales data, and the audience segment, generating a relative value forecast comprising a relative spend value per dollar for each vehicle model visit based on the cost to generate the vehicle model visit, the sales goal data, the vehicle sales data, and the audience segment, generating a budget change and a bid change for a resource campaign by comparing an original budget and an original bid for the resource campaign to the needs forecast and the relative value forecast, and applying the budget change and the bid change to the resource campaign.

### TECHNICAL FIELD

The present disclosure relates to resource optimization using audience segmentation data.

### BRIEF DESCRIPTION OF THE DRAWINGS

FIG. 1A is a block diagram of a device according to one embodiment.

FIG. 1B is a block diagram of a device according to one embodiment.

FIG. 2 is a block diagram of a system for campaign optimization according to one embodiment.

FIG. 3 is a block diagram for an audience campaign module according to one embodiment.

FIG. 4 is a flowchart of a method for resource campaign optimization according to one embodiment.

FIG. 5 is a flowchart of a method for resource campaign optimization according to one embodiment.

### DETAILED DESCRIPTION OF PREFERRED EMBODIMENTS

Resources utilized in advertising media can be evaluated by the marketing costs per vehicle sold. The resources utilized in advertising media can be allocated based on a dealer's vehicle inventory and sales demand.

A marketing budget can include bids, which can be allocated and/or adjusted using online audience segmentation, vehicle sales, and lot inventory to drive business goals. By analyzing online audience segmentation for vehicle models, the vehicle sales of vehicle models, the sales goals for vehicle models, and the cost to advertise to the audience segment, the system can optimize resources spent and/or advertising bids on campaigns to achieve the sales goal for a vehicle model based on the relative distance between the forecast for a target audience and the sales goals.

Reference is now made to the figures, in which like reference numerals refer to like elements. For clarity, the first digit of a reference numeral indicates the figure number in which the corresponding element is first used. In the following description, numerous specific details are provided for a thorough understanding of the embodiments disclosed herein. However, those skilled in the art will recognize that the embodiments described herein can be practiced without one or more of the specific details, or with other methods, components, or materials. Further, in some cases, well-known structures, materials, or operations are not shown or described in detail in order to avoid obscuring aspects of the embodiments. Furthermore, the described features, structures, or characteristics may be combined in any suitable manner in one or more embodiments.

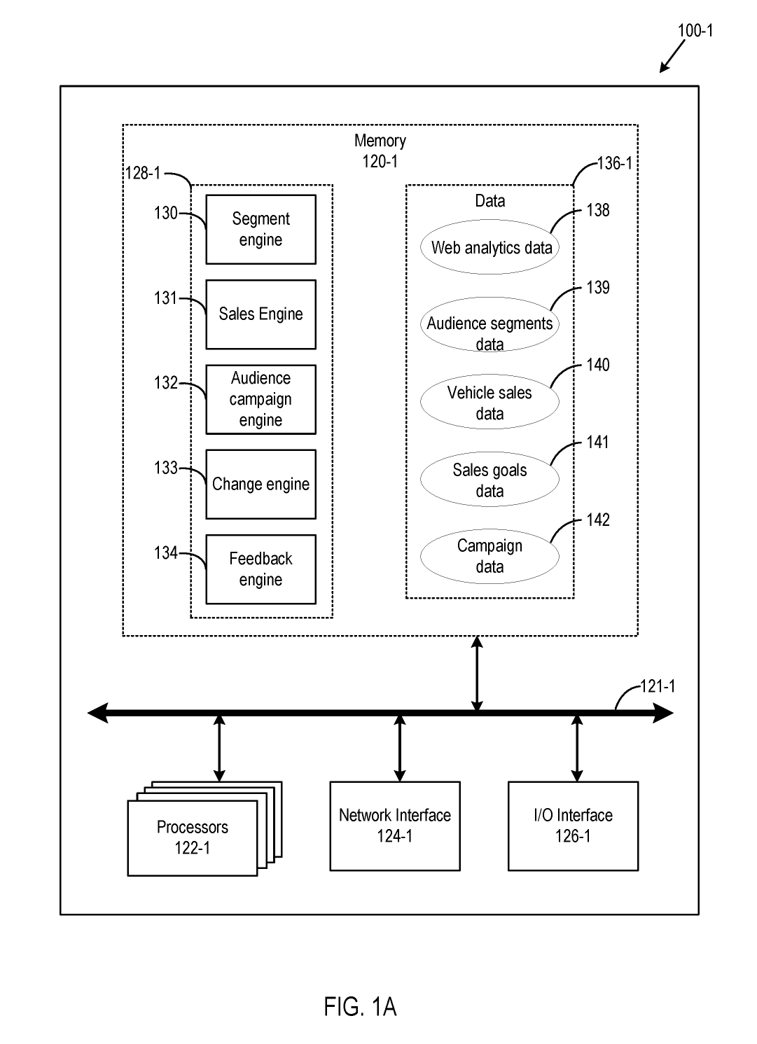

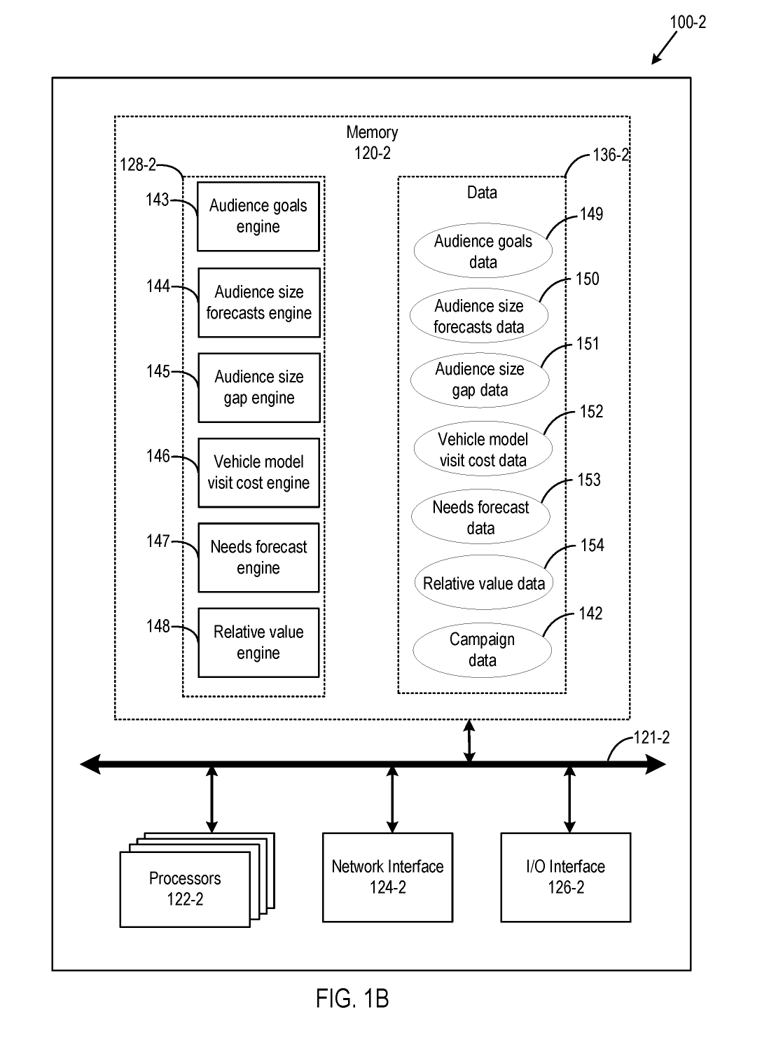

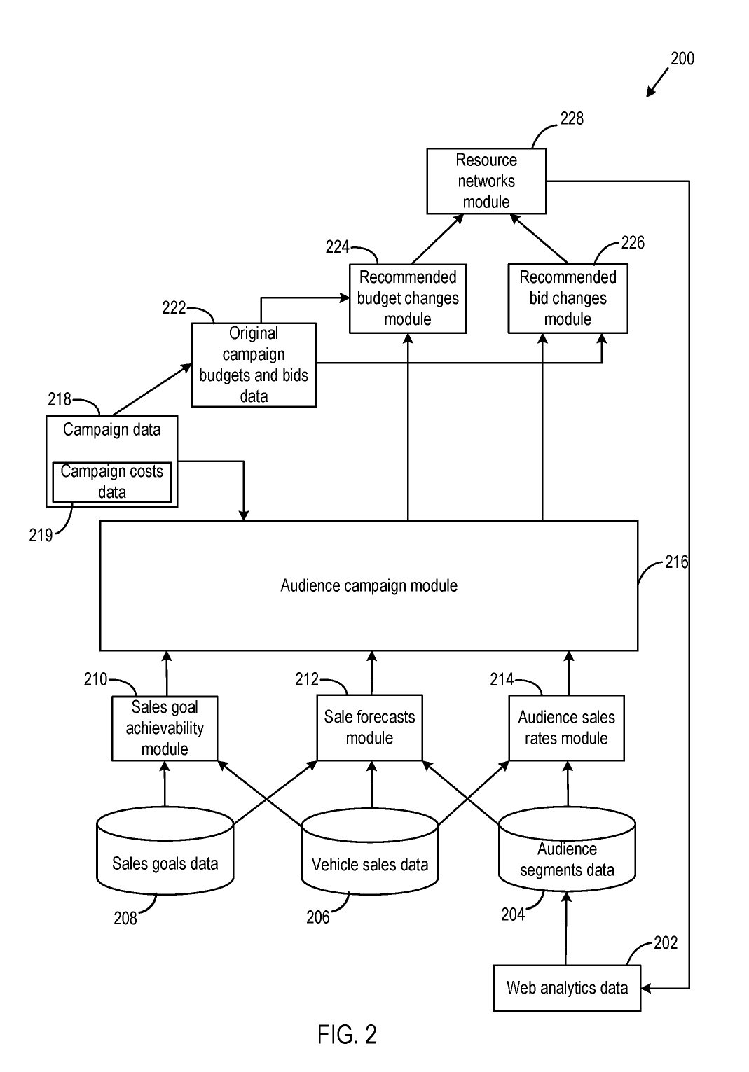

FIG. 1A is a block diagram of a device 100-1 according to one embodiment. The device 100-1 can provide data to the system 200 (FIG. 2) to configure the system 200. The device 100-1 can include a memory 120-1, one or more processors 122-1, a network interface 124-1, an input/output interface 126-1, and a system bus 121-1.

The one or more processors 122-1 may include one or more general-purpose devices, such as an Intel®, AMD®, or other standard microprocessor. The one or more processors 122-1 may include a special-purpose processing device, such as an ASIC, SoC, SiP, FPGA, PAL, PLA, FPLA, PLD, or other customized or programmable device. The one or more processors 122-1 can perform distributed (e.g., parallel) processing to execute or otherwise implement functionalities of the presently disclosed embodiments. The one or more processors 122-1 may run a standard operating system and perform standard operating system functions. It is recognized that any standard operating system may be used, such as, for example, Microsoft® Windows®, Apple® MacOS®, Disk Operating System (DOS), UNIX, IRJX, Solaris, SunOS, FreeBSD, Linux®, ffiM® OS/2®, and so forth.

The memory 120-1 may include static RAM, dynamic RAM, flash memory, one or more flip-flops, ROM, CD-ROM, DVD, disk, tape, or magnetic, optical, or other computer storage medium. The memory 120-1 may include a plurality of program engines 128-1 and program data 136-1. The memory 120-1 may be local to the device 100-1, as shown, or may be distributed and/or remote relative to the device 100-1.

The program engines 128-1 may include all or portions of other elements of the system 200. The program engines 128-1 may run multiple operations concurrently or in parallel by or on the one or more processors 122-1. In some embodiments, portions of the disclosed engines, components, and/or facilities are embodied as executable instructions embodied in hardware or firmware, or stored on a non-transitory, machine-readable storage medium, such as the memory 120-1. The instructions may comprise computer program code that, when executed by a processor and/or computing device, causes a computing system (such as the processors 122-1 and/or the device 100-1) to implement certain processing steps, procedures, and/or operations, as disclosed herein. The engines, modules, components, and/or facilities disclosed herein may be implemented and/or embodied as a driver, a library, an interface, an API, FPGA configuration data, firmware (e.g., stored on an EEPROM), and/or the like. In some embodiments, portions of the engines, components, and/or facilities disclosed herein are embodied as machine components, such as general and/or application-specific devices, including, but not limited to: circuits, integrated circuits, processing components, interface components, hardware controller(s), storage controller(s), programmable hardware, FPGAs, ASICs, and/or the like. Accordingly, the engines disclosed herein may be referred to as controllers, layers, services, modules, facilities, drivers, circuits, and/or the like.

The memory 120-1 may also include the program data 136-1. Data generated by the system 200, such as by the program engines 128-1 or other engines, may be stored on the memory 120-1, for example, as the stored program data 136-1. The stored program data 136-1 may be organized as one or more databases. In certain embodiments, the program data 136-1 may be stored in a database system. The database system may reside within the memory 120-1. In other embodiments, the program data 136-1 may be remote, such as in a distributed computing and/or storage environment. For example, the program data 136-1 may be stored in a database system on a remote computing device.

The input/output interface 126-1 may facilitate interfacing with one or more input devices and/or one or more output devices. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The network interface 124-1 may facilitate communication with other computing devices and/or networks and/or other computing and/or communications networks. The network interface 124-1 may be equipped with conventional network connectivity, such as, for example, Ethernet (IEEE 802.3), Token Ring (IEEE 802.5), Fiber Distributed Datalink Interface (FDDI), or Asynchronous Transfer Mode (ATM). Further, the network interface 124-1 may be configured to support a variety of network protocols such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth.

The system bus 121-1 may facilitate communication and/or interaction between the other components of the device 100-1, including the one or more processors 122-1, the memory 120-1, the input/output interface 126-1, and the network interface 124-1.

As noted, the device 100-1 also includes the various program engines 128-1 (or modules or components) to implement functionalities of the device 100-1, including a segment engine 130, a sales engine 131, an audience campaign engine 132, a change engine 133, and/or a feedback engine 134. These elements may be embodied, for example, at least partially in the program engines 128-1. In other embodiments, these elements may be embodied or otherwise implemented in hardware of the device 100-1. The device 100-1 also includes web analytics data 138, audience segments data 139, vehicle sales data 140, sales goals data 141, and campaign data 142 that may be stored in the program data 136-1 which may be generated, accessed, and/or manipulated by the program engines 128-1.

The segment engine 130 is configured to create a plurality of audience segments, from consumer data, corresponding to vehicle models. The plurality of audience segments can be stored as the audience segments data 139.

The sales engine 131 is configured to generate sales goal achievability data corresponding to vehicle models, a plurality of sale forecasts corresponding to vehicle models, and/or a plurality of audience sales rates corresponding to vehicle models. The sales goal achievability data can be generated from the sales goals data 141 and/or the vehicle sales data 140. The plurality of sale forecasts can be generated from the sales goals data 141, the vehicle sales data 140, and/or audience segments data 139. The plurality of audience sales rates can be generated from the vehicle sales data 140 and/or the audience segments data 139.

The audience campaign engine 132 is configured to generate a needs forecast and a relative value forecast from the sales goals data 141, the vehicle sales data 140, the audience segments data 139, and/or the campaign data 142. The change engine 133 is configured to generate a recommended budget change and a recommended bid change for a resource campaign by comparing the original budget and the original bid for the resource campaign to the needs forecast and the relative value forecast. The feedback engine 134 is configured to apply the budget change and the bid change to the resource campaign to generate consumer data. The program engines 128 can utilize the web analytics data 138, the audience segments data 139, the vehicle sales data 140, the sales goals data 141, and the campaign data 142.

FIG. 1B is a block diagram of a device 100-2 according to one embodiment. The device 100-2 includes a memory 120-2, one or more processors 122-2, a network interface 124-2, an input/output interface 126-2, and a system bus 121-2. The memory 120-2 is analogous to the memory 120-1. The one or more processors 122-2, the network interface 124-2, the input/output interface 126-2, and the system bus 121-2 are analogous to the one or more processors 122-1, the network interface 124-1, the input/output interface 126-1, and the system bus 121-1, respectively. The memory 120-2 may include a plurality of program engines 128-2 and program data 136-2. The memory 120-2 may be local to the device 100-2, as shown, or may be distributed and/or remote relative to the device 100-2.

The device 100-2 can implement an audience campaign engine 132. The plurality of program engines 128-2 includes at least an audience goals engine 143, an audience size forecasts engine 144, an audience size gap engine 145, a vehicle model visit cost engine 146, a needs forecast engine 147, and a relative value engine 148. The program data 136-2 includes audience goals data 149, audience size forecasts data 150, audience size gap data 151, vehicle model visit cost data 152, needs forecast data 153, relative value data 154, and campaign data 142.

The audience goals engine 143 generates the audience goals data 149 from the sales goal achievability data, the sale forecasts data, and/or the audience sales rates data generated by the sales engine 131 in FIG. 1A. The audience size forecasts engine 144 generates the audience size forecasts data 150 from the sales goal achievability data, the sale forecasts data, and/or the audience sales rates data generated by the sales engine 131. The audience size gap engine 145 generates the audience size gap data 151 by comparing the audience goals data 149 to the audience size forecasts data 150.

The vehicle model visit cost engine 146 generates the vehicle model visit cost data 152 based on the campaign data 142. The needs forecast engine 147 generates the needs forecast data 153 comprising a needed budget (e.g., needed ad budget) based on the audience size gap data 151 and/or the vehicle model visit cost data 152. The relative value engine 148 generates the relative value data 154 comprising a relative spend value per dollar for each model visit from the audience size gap data 151 and/or the vehicle model visit cost data 152.

In some examples, the devices 100-1 and/or 100-2 and/or the plurality of program engines 128-1 and 128-2 (e.g., the engines 130, 131, 132, 133, 134, 144, 145, 146, 147, and/or 148) of FIGS. 1A and 1B can be implemented in a single computing device and/or a plurality of computing devices coupled via a computing network. The devices 100-1 and/or 100-2 and/or the plurality of program engines 128-1 and 128-2 can also be implemented in a cloud environment.

For example, each of the engines 130, 131, 132, 133, 134, 144, 145, 146, 147, and/or 148 can be stored and/or generated in one or more computing devices. Each of the engines 130, 131, 132, 133, 134, 144, 145, 146, 147, and/or 148 can store data, share the data 136-1 and 136-2, and/or provide notifications with each other using one or more networks. The one or more networks can be any combination of private networks or public networks.

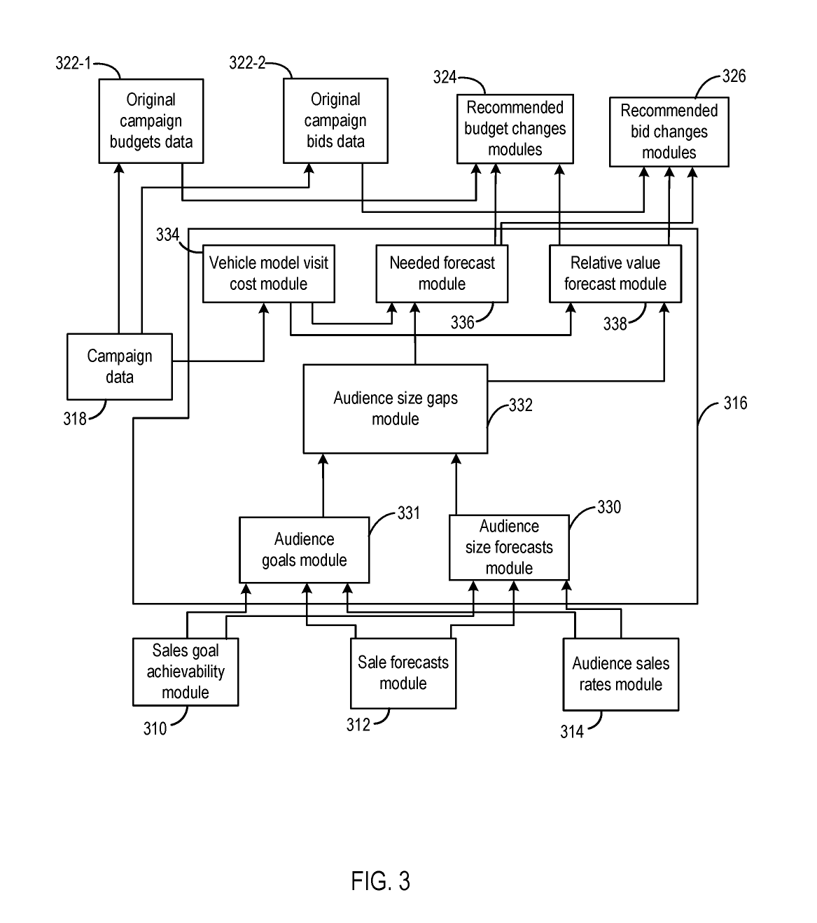

FIG. 2 is a block diagram of a system 200 for optimization according to one embodiment. The system 200 can include web analytics data 202, audience segments data 204, vehicle sales data 206, sales goals data 208, a sales goal achievability module 210, a sales forecasts module 212, an audience sales rates module 214, an audience campaign module 216, campaign data 218, original campaign budget and bids data 222, a recommended budget changes module 224, and a recommended bid changes module 226. The modules shown in FIGS. 2 and 3 can be software implementations of the engines 130, 131, 132, 133, 134, 144, 145, 146, 147, and/or 148 of FIGS. 1A and 1B. As such, the modules can be implemented in the devices 100-1 and/or 100-2. A resource network module 228 may or may not be part of the system 200.

The web analytics data 202 can comprise consumer behavior data that can be gathered in real time and/or in batches. The system 200 can process, via one or more computing devices, the web analytics data 202 to generate the audience segments data 204. The audience segments data 204 divide users visiting a website into subgroups based upon the users' use of the website. For example, users can be divided into subgroups based on a web page visited by the users. The users can be divided into subgroups based on the interaction of the users with the website and/or web page. In some examples, the subgroups can include vehicle models, vehicle types, and/or vehicle makers. For examples, a first audience segment can be a first quantity of users grouped into a first subgroup based on the first quantity of users' interest in a first vehicle model. A second audience segment can be a second quantity of users grouped into a second subgroup based on the second quantity of users' interest in a second vehicle model. In some examples, the audience segments data 204 can include audience segments that are exclusive or inclusive. That is, users can belong to a single audience segment and/or to multiple audience segments.

The vehicle sales data 206 can include data describing vehicle sales for a plurality of vehicle models. The vehicle sales data 206 can describe actual vehicle sales in a time duration. As used herein, a time duration can include a duration of time between a start time and an end time. A time duration can be a minute, an hour, a day, or a week, among other examples of a time duration. In some examples, the vehicle sales data 206 can describe a present quantity of vehicle sales at a time that is after the start time of the time duration but before the end time of the time duration. That is, the vehicle sales data 206 can describe ongoing vehicle sales.

The vehicle sales data 206 can be generated offline. That is, in some examples vehicles sales used to generate, by a computing device, the vehicle sales data 206 do not occur on a website but can occur offline. The vehicles sales used to generate the vehicle sales data 206 can also occur online or in a combination of online and offline. As used herein, online refers to the real time availability of data. Offline refers to the availability of data not in real time but in batches. For example, the offline generation of vehicle sales data 206 describes that the vehicle sales data 206 is not available to the system 200 in real time but rather is made available to the system 200 in batches at diverse time intervals. Data can be available in a combination of online and offline if portions of the data are available in real time while other portions of the data are not available in real time.

The vehicle sales data 206 can be stored in hardware using software and made available to the system 200. For example, if the vehicle sales data 206 are stored offline, then the vehicle sales data 206 can be stored in one or more databases that are stored in one or more servers and/or on a cloud system. The vehicle sales data 206 can be provided to the system 200 via a private network and/or a public network.

The vehicle sales 206 can be used to determine an inventory of vehicles of a plurality of vehicle models at a dealership. For example, given an inventory of a dealership at a beginning of a time period, the vehicle sales data 206 can be subtracted from the inventory to determine an inventory of the dealership at a point in time. The inventory can define the availability of particular vehicles of a vehicle mode, a plurality of vehicles of a vehicle type, and/or a plurality of vehicles of a vehicle maker.

A dealership can comprise a plurality of vehicles at a location and/or at a plurality of locations. A dealership can be owned by a single entity and/or a plurality of entities. A dealership can comprise an Internet presence and/or a brick-and-mortar presence.

The system 200 can also comprise the sales goals data 208. The sales goals data 208 can describe one or more sales goals for each of a plurality of vehicle models. For example, the sales goals data 208 can comprise a first sale goal for a first vehicle model and a second sales goal for a second vehicle model. The sales goals data 208 can also be defined by a duration of time. The duration of time associated with the sales goals data 208 can be a same duration of time as (e.g., or a different time duration from) the duration of time associated with the vehicle sales data 206. For example, a duration of time of a month can be associated with the sales goals data 208 and the vehicle sales data 206. The sales goals data 208 can be defined by a dealership and/or a plurality of dealerships.

In some examples, an inventory of a dealership can be used to generate the sales goals data 208. The inventory can also affect the vehicle sales data 206 and/or the audience segments data 204.

The sales goal achievability module 210 can generate sales goal achievability data for the vehicle models based on the sales goals data 208, the vehicle sales data 206, and/or audience size goals via one or more computing devices. For example, the sales goal achievability module 210 can compare the sales goals data 208 and the vehicle sales data 206 to generate the sales goal achievability data. The computing devices can include hardware and software. For example, the computing device can comprise memory and one or more processing devices. The computing device can comprise software in the form of computer readable instructions to store and process data.

The computing device can be local to the system 200 and/or external to the system 200. For example, the computing device that generates the sales goal achievability module 210 can be housed in a cloud system that is external to the system 200.

The sales goal achievability module 210 can generate sales goal achievability data for each vehicle model. The sales goal achievability data can include sales forecasts utilizing model audience data and vehicle model sales relative to the model sales goal. The sales forecasts module 212 can generate sales forecasts data from the sales goals data 208, the vehicle sales data 206, and/or the audience segments data 204. The sales forecasts data can describe an expected quantity of sales for each of a plurality of vehicle models. For example, the expected quantity of sales can define a quantity of sales that are expected at an end time associated with a time duration. Each sales forecast from the sales forecasts data can be associated with a different one of the vehicle models offered by a dealership.

The sales forecasts data can be used by the system 200 to determine audience size forecasts data via audience size forecasts module 330 in FIG. 3. The audience size forecasts data can define the audience size needed to achieve the sales forecast associated with the sales forecast data. That is, the audience size forecasts can be a desired quantity of customers that are targeted to visit a dealership and/or a website associated with the dealership to achieve the sales forecast. The audience size forecasts can be generated, via a computing device, from the sales forecast data, the audience sales rates data, and/or the sales goal achievability data.

The audience sales rates module 214 can generate the audience sales rates data based on the vehicle sales 206 and the audience segments data 204. The audience sales data can define a ratio of an audience size to a sale. That is, the audience sales rates data can define a sales rate for a specific audience. For example, the audience sales rates data can define that 200 shoppers of a vehicle model are expected to visit a dealership before a sale of the vehicle model is made.

The audience campaign module 216 receives the sales goal achievability data, the sales forecasts data, the audience sales rates data, and/or the campaign data 218 to generate needed forecast data and relative value forecast data as described in FIG. 2. The needed forecast data can define a needed budget (e.g., needed ad budget) that is needed to meet the sales goal achievability data. The relative value forecast data can define a relative spend value of a dollar for each model visit. The relative spend value of dollar for each model vising can be used to calibrate budget allocation based on the relative sales need and the relative return on investment (ROI) of each budget dollar by linking the cost of a model visit, to the conversion rate of the model audience segment, to the sales need.

The campaign data 218 can comprise campaign costs data 219. The campaign costs data 219 can describe the costs associated with a resource campaign. For example, the costs associated with a resource campaign can define a cost per vehicle model visit. That is, the costs associated with the resource campaign can describe a cost of generating a vehicle model visit.

The campaign data 218 can also comprise the original campaign budget and bids data 222. The original campaign budget and bids data 222 can define an original campaign budget and an original campaign bid. The original campaign budget can define a resource campaign budget before an optimization is implemented. The original campaign bid can define a bid for a resource (e.g., advertisement) before an optimization is implemented.

The recommended budget changes module 224 and the recommended bid changes module 226 can generate recommended budget changes data and recommended bid changes data from the original campaign budgets and bids data 222, the needed forecast data, and/or the relative value forecast data. The recommended budget changes data and the recommended bid changes data can be implemented by resource network module 228. Implementing the recommended bid changes data and the recommended budget changes data can include amending the original campaign budgets and bids at a resource network based on the recommended bid changes data and the recommended budget changes data. The resource network can include hardware and/or software to process the recommended budget changes and/or the recommended bid changes as part of a resource campaign via the resource network module 228.

The original campaign budget data and the recommended budget changes data can be specific to a vehicle model and/or can be general to a plurality of vehicle models. The original campaign bids data and the recommended bid changes data can be specific to a vehicle model and/or can be general to a plurality of vehicle models.

In some examples, the resource network module 228 can generate consumer data which can be included in the web analytics data 202. That is, the resource network module 228 can provide feedback to the system 200 by generating data that is included in the web analytics data 202 through the actions that the consumers take as a result of the resource changes. The feedback can be provided continuously and/or in batches over a duration of time.

FIG. 3 is a block diagram of an audience campaign module 316 according to one embodiment. The audience campaign module 316 is analogous to the audience campaign module 216 in FIG. 2. Audience sales rates module 314, sales forecasts module 312, and sales goal achievability module 310 are analogous to the audience sales rates module 214, the sales forecasts module 212, and the sales goal achievability module 210 in FIG. 2, respectively. Campaign data 318 is also analogous to the campaign data 218. An original campaign budgets data 322-1 and original campaign bids data 322-2 are analogous to the original campaign budget and bids data 222. Recommended budget changes module 324 and recommended bid changes module 326 are analogous to the recommended budget changes module 224 and the recommended bid changes module 226 in FIG. 2, respectively.

The audience campaign module 316 can receive the sales goal achievability data from the sales goal achievability module 310, the sales forecasts data from the sales forecasts module 312, and the audience sales rates data from the audience sales rates module 314. The audience size forecasts module 330 can generate the audience size forecasts data for each vehicle model from the sales goal achievability data, the sale forecasts data, and/or the audience sales rates data. The audience size forecasts data can describe the expected model audience and/or the visitor volume based on the data to date in the forecast period assuming the current system state is maintained. The audience goals module 331 can generate audience goals data for each vehicle model using the sales goal achievability data, the sales forecasts data, and/or the audience sales rates data. The audience goals data can describe the needed model audience and/or the visitor volume based on the desired model sales. The audience goals data can describe an audience size needed to meet the sales goals data associated with the sales goal achievability module 310.

The audience size gaps modules 332 can compare the audience goals data to the audience size forecasts data to generate audience size gaps data. The audience size gaps data can comprise a plurality of audience size gaps. The audience size gaps can be the difference between the audience goals and the audience size forecasts. For example, if the audience goal needed to meet the sales goal achievability data is X and the audience size forecast needed to meet the sales forecasts data is Y, then the audience size gap can be expressed as X-Y.

The campaign data 318 can be received and used by the audience campaign module 316 to generate vehicle model visit cost data. That is, the vehicle model visit cost module 334 can generate, identify, and/or isolate vehicle model visit cost data from the campaign data 318. The vehicle model visit cost data can express the cost to generate a vehicle model visit. That is, the vehicle model visit cost data can describe a quantity of resources expended to generate a customer visit to a dealership for a vehicle model.

The needed forecast module 336 can generate needed forecast data from the vehicle model visit cost data and the audience size gaps data. The relative value forecast module 338 can generate relative value forecast data from the vehicle model visit cost data and the audience size gaps data.

The needed forecast data can describe a needed budget (e.g., needed ad budget) needed to meet the audience size gap describe in the audience size gap data. That is, the needed forecast data can define resources that are needed, above those already allocated, to meet the audience size forecasts data generated from the audience size forecasts module 330.

The relative value forecast data can describe the relative ROI of each incremental audience visitor by looking at the acquisition cost of each visitor in each model audience segment and the overall sales (and thus audience size) need for each model segment.

The recommended budget changes module 324 can generate the recommended budget changes from the original campaign budgets data 322-1, the original campaign bids data 322-2, the needed forecast data, and/or the relative value forecast data. The recommended bid changes module 326 can generate recommended bid changes from the original campaign budgets data 322-1, the original campaign bids data 322-2, the needed forecast data, and/or the relative value forecast data.

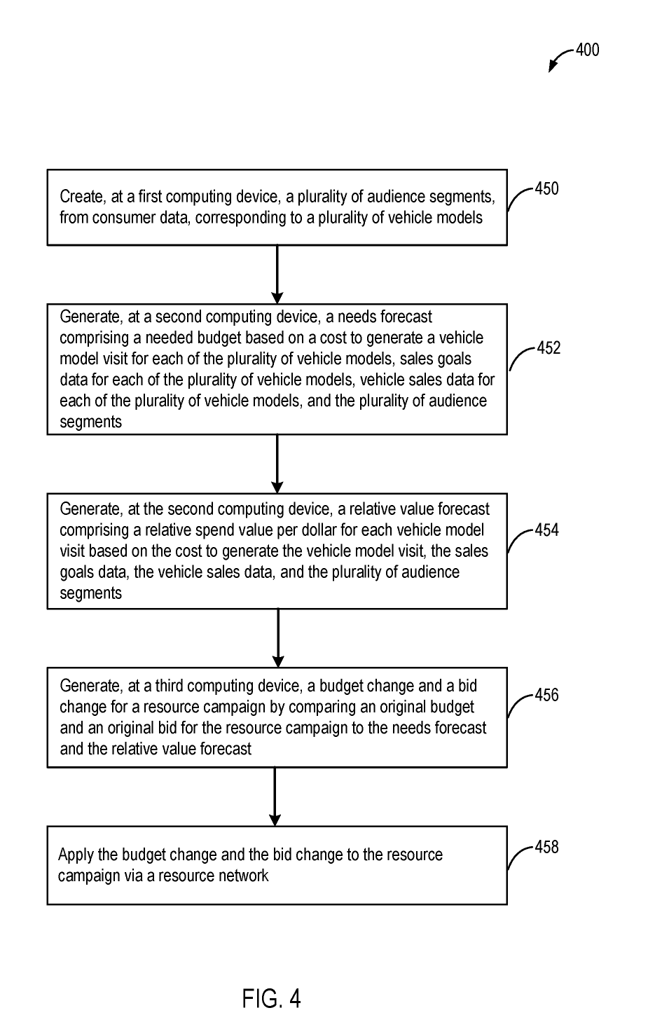

FIG. 4 is a flowchart of a method 400 for resource campaign optimization according to one embodiment. The method can include creating 450, at a first computing device, a plurality of audience segments, from consumer data, corresponding to a plurality of vehicle models and generating 452, at a second computing device, a needs forecast comprising a needed budget based on a cost to generate a vehicle model visit for each of the plurality of vehicle models, sales goals data for each of the plurality of vehicle models, vehicle sales data for each of the plurality of vehicle models, and the plurality of audience segments. The method can also include generating 454, at the second computing device, a relative value forecast comprising a relative spend value per dollar for each vehicle model visit based on the cost to generate the vehicle model visit, the sales goals data, the vehicle sales data, and the plurality of audience segments; generating 456, at a third computing device, a budget change and a bid change for a resource campaign by comparing an original budget and an original bid for the resource campaign to the needs forecast and the relative value forecast; and applying 458 the budget change and the bid change to the resource campaign via a resource network.

The method can also include generating sales goal achievability data for each of the plurality of vehicle models by comparing the sales goals data to the vehicle sales data. The method can also include joining the plurality of audience segments, the sales goals data, and the vehicle sales data to generate a sales forecast for each of the plurality of vehicle models. As used herein, joining includes using ratios, such as model audience size per model vehicle sold, and the translated or converted unit metrics to enable leveraging a related data stream to improve the quality of the data generated by the method. In some examples, the method can include comparing the audience segments to the vehicle sales data to generate an audience sales rate for each of the plurality of vehicle models.

Generating 452 the needs forecast can further comprise generating the needs forecast based on the sales goal achievability data, the sales forecasts data, and the audience sales rates data. Generating 454 the relative value forecast further comprises generating the relative value forecast based on the sales goal achievability data, the sales forecasts data, and the audience sales rates data.

The method can also include generating an audience size forecast for each of the plurality of vehicle models from the sales goal achievability data, the sales forecasts data, and the audience sales rates data. The method can also include generating an audience goal for each of a plurality of vehicle models from the sales goal achievability data, the sales forecasts data, and the audience sales rates data. The method can further include generating an audience size gap for each vehicle model from the audience size forecasts and the audience goals. The audience size gap can include a gap between an audience size goal needed to meet the sales goal achievability data and an audience size forecast needed to meet the sales forecast.

Generating 452 the needs forecast further comprises generating the needs forecast based on the audience size gap for each model and the cost to generate the vehicle model visit. Generating 454 the relative value forecast further comprises generating the relative value forecast based on the relative audience size gap for each model and the cost to generate the vehicle model visit.

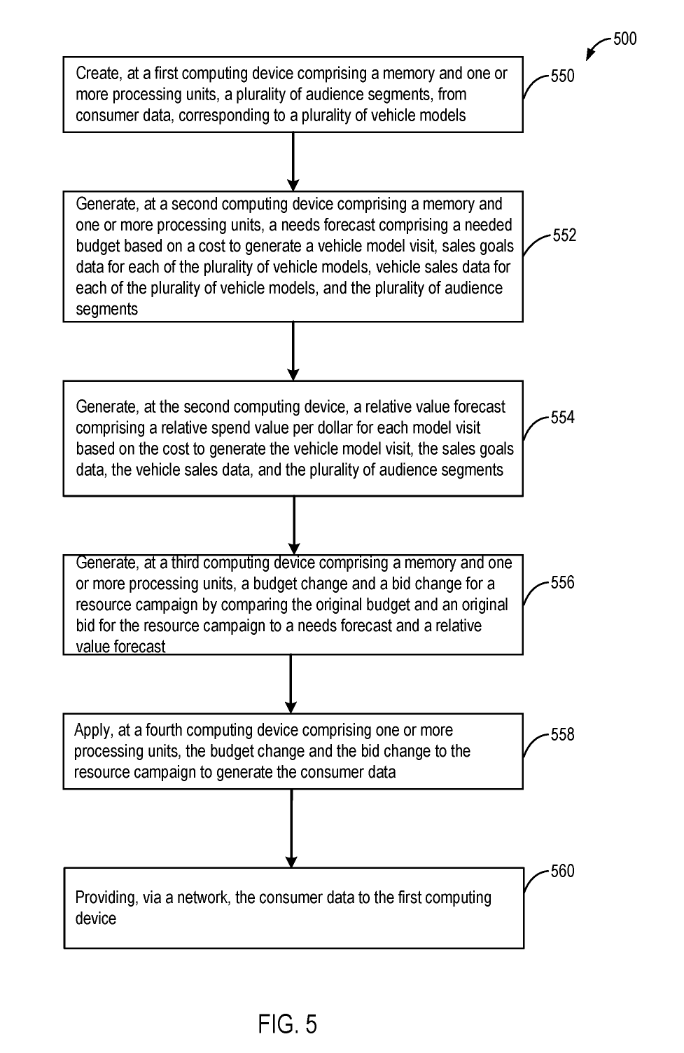

FIG. 5 is a flowchart of a method 500 for resource campaign optimization according to one embodiment. The method can include creating 550, at a first computing device comprising memory and one or more processing units, a plurality of audience segments, from consumer data, corresponding to a plurality of vehicle models; generating 552, at a second computing device comprising memory and one or more processing units, a needs forecast comprising a needed budget based on a cost to generate a vehicle model visit, sales goals data for each of the plurality of vehicle models, vehicle sales data for each of the plurality of vehicle models, and the plurality of audience segments; and generating 554, at the second computing device, a relative value forecast comprising a relative spend value per dollar for each vehicle model visit based on the cost to generate the vehicle model visit, the sales goals data, the vehicle sales data, and the plurality of audience segments. The method can also include generating 556, at a third computing device comprising one or more processing units, a budget change and a bid change for a resource campaign by comparing the original budget and original bid for the resource campaign to a needs forecast and a relative value forecast; applying 558, at a fourth computing device comprising one or more processing units, the budget change and the bid change to the resource campaign to generate the consumer data; and providing 560, via a network, the consumer data to the first computing device.

Providing 560 the consumer data to the first computing device further comprises providing the consumer data to the first computing device every predetermined time interval. Providing 560 the consumer data to the first computing device further comprises providing the consumer data to the first computing device in real time.

The method further comprises generating web analytics data, at the first computing device, from the consumer data. In some examples, creating 550 the plurality of audience segments from the consumer data further comprises creating the plurality of audience segments from the web analytics data.

Furthermore, the described features, operations, or characteristics may be arranged and designed in a wide variety of different configurations and/or combined in any suitable manner in one or more embodiments. Thus, the detailed description of the embodiments of the systems and methods is not intended to limit the scope of the disclosure, as claimed, but is merely representative of possible embodiments of the disclosure. In addition, it will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps, or by a combination of hardware, software, and/or firmware.

Embodiments may also be provided as a computer program product including a computer-readable storage medium having stored instructions thereon that may be used to program a computer (or other electronic device) to perform processes described herein. The computer-readable storage medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of medium/machine-readable medium suitable for storing electronic instructions.

As used herein, a software module or component may include any type of computer instruction or computer-executable code located within a memory device and/or computer-readable storage medium. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

It will be obvious to those having skill in the art that many changes may be made to the details of the above-described embodiments without departing from the underlying principles of the invention. The scope of the present invention should, therefore, be determined only by the following claims.

What is claimed is:

1. A device for applying budget changes and bid changes to a resource campaign, comprising:
an electronic memory to store consumer data corresponding to a vehicle model, cost per vehicle model visit, sales goals data for the vehicle model, vehicle sales data for the vehicle model, and an audience segment; and
one or more processing units configured to:
create the audience segment, from the consumer data;
generate a needs forecast comprising a needed budget based on the cost to generate the vehicle model visit, the sales goals data, the vehicle sales data, and the audience segment;
generate a relative value forecast comprising a relative spend value per dollar for each vehicle model visit based on the cost to generate the vehicle model visit, the sales goal data, the vehicle sales data, and the audience segment;
generate a budget change and a bid change for a resource campaign by comparing an original budget and an original bid for the resource campaign to the needs forecast and the relative value forecast; and
apply the budget change and the bid change to the resource campaign.

2. The device of claim 1, wherein the one or more processing units configured to create the audience segment, from the consumer data, are further configured to create the audience segment, from web analytics data, wherein the consumer data comprises the web analytics data.

3. The device of claim 1, wherein the sale goals data describes a desired quantity of sales of the vehicle model.

4. The device of claim 1, wherein the vehicle sales data describes an actual quantity of sales of the vehicle model.

5. The device of claim 1, wherein the one or more processing units are further configured to generate the cost per vehicle model visit from campaign data.

6. A computer-readable storage medium having stored thereon instructions that, when implemented by a computing device, cause the computing device to:
create, at a first computing device, a plurality of audience segments, from consumer data, corresponding to a plurality of vehicle models;
generate, at a second computing device, a needs forecast comprising a needed budget based on a cost to generate a vehicle model visit for each of the plurality of vehicle models, sales goals data for each of the plurality of vehicle models, vehicle sales data for each of the plurality of vehicle models, and the plurality of audience segments;
generate, at the second computing device, a relative value forecast comprising a relative spend value per dollar for each vehicle model visit based on the cost to generate the vehicle model visit, the sales goals data, the vehicle sales data, and the plurality of audience segments;
generate, at a third computing device, a budget change and a bid change for a resource campaign by comparing an original budget and an original bid for the resource campaign to the needs forecast and the relative value forecast; and
apply the budget change and the bid change to the resource campaign via a resource network.

7. The computer-readable storage medium of claim 6, further comprising instructions to generate sales goal achievability data for each of the plurality of vehicle models by comparing the sales goals data to the vehicle sales data.

8. The computer-readable storage medium of claim 7, further comprising instructions to join the plurality of audience segments, the sales goals data, and the vehicle sales data to generate sales forecast data for each of the plurality of vehicle models.

9. The computer-readable storage medium of claim 8, further comprising instructions to compare the audience segments to the vehicle sales data to generate an audience sales rate data for each of the plurality of vehicle models.

10. The computer-readable storage medium of claim 9, wherein the instructions to generate the needs forecast further comprise instructions to generate the needs forecast based on the sales goal achievability data, the sales forecasts data, and the audience sales rates data.

11. The computer-readable storage medium of claim 9, wherein the instructions to generate the relative value forecast further comprise instructions to generate the relative value forecast based on the sales goal achievability data, the sales forecasts data, and the audience sales rates data.

12. The computer-readable storage medium of claim 9, further comprising instructions to generate an audience size forecast for each of the plurality of vehicle models from the sales goal achievability data, the sales forecasts data, and the audience sales rates data.

13. The computer-readable storage medium of claim 12, further comprising instructions to generate an audience goal for each of a plurality of vehicle models from the sales goal achievability data, the sales forecasts data, and the audience sales rates data.

14. The computer-readable storage medium of claim 13, further comprising instructions to generate an audience size gap for each vehicle model from the audience size forecast and the audience goals.

15. The computer-readable storage medium of claim 14, wherein the audience size gap comprises a gap between an audience size goal needed to meet the sales goal achievability data and an audience size forecast needed to meet the sales forecast data.

16. The computer-readable storage medium of claim 14, wherein the instructions to generate the needs forecast further comprise instructions to generate the needs forecast based on the audience size gap for each vehicle model and the cost to generate the vehicle model visit.

17. The computer-readable storage medium of claim 14, wherein the instructions to generate the relative value forecast further comprise instructions to generate the relative value forecast based on the relative audience size gap for each vehicle model and the cost to generate the vehicle model visit.

18. A method for applying budget changes and bid changes to a resource campaign, comprising:
creating, at a first computing device comprising a memory and one or more processing units, a plurality of audience segments, from consumer data, corresponding to a plurality of vehicle models;
generating, at a second computing device comprising a memory and one or more processing units, a needs forecast comprising a needed budget based on a cost to generate a vehicle model visit, sales goals data for each of the plurality of vehicle models, vehicle sales data for each of the plurality of vehicle models, and the plurality of audience segments;
generating, at the second computing device, a relative value forecast comprising a relative spend value per dollar for each vehicle model visit based on the cost to generate the vehicle model visit, the sales goals data, the vehicle sales data, and the plurality of audience segments;
generating, at a third computing device comprising a memory and one or more processing units, a budget change and a bid change for a resource campaign by comparing an original budget and an original bid for the resource campaign to a needs forecast and a relative value forecast;
applying, at a fourth computing device comprising a memory and one or more processing units, the budget change and the bid change to the resource campaign to generate the consumer data; and
providing, via a network, the consumer data to the first computing device.

19. The method of claim 18, wherein providing the consumer data to the first computing device further comprises providing the consumer data to the first computing device every predetermined time interval.

20. The method of claim 18, wherein providing the consumer data to the first computing device further comprises providing the consumer data to the first computing device in real time.

21. The method of claim 18, further comprising generating web analytics data, at the first computing device, from the consumer data.

22. The method of claim 21, further comprising creating a plurality of audience segments from the consumer data further comprises creating the plurality of audience segments from the web analytics data.
